(19) United States
(12) Patent Application Publication
(10) Pub. No.: US 2025/0053997 A1
(43) Pub. Date: Feb. 13, 2025

(54) METHOD AND ASSESSMENT SYSTEM FOR ASSESSING PERFORMANCE OF PLURALITY OF OUTLETS

(71) Applicant: EdgeVerve Systems Limited, Bengaluru (IN)

(72) Inventors: Mayank SHRIDHAR, Ranchi (IN); Suresh P BHARADWAJ, Frisco, TX (US); Sagar SARMA, Bangalore (IN)

(73) Assignee: EdgeVerve Systems Limited, Bengaluru (IN)

(21) Appl. No.: 18/431,777

(22) Filed: Feb. 2, 2024

(30) Foreign Application Priority Data
Aug. 9, 2023 (IN) 202341060565

(51) Int. Cl. G06Q 30/018; G06Q 10/0639; G06Q 10/087

(52) U.S. Cl. CPC G06Q 30/018; G06Q 10/06393; G06Q 10/087

(57) ABSTRACT

The present disclosure discloses method of assessing performance of a plurality of outlets. The assessment system receives monitored data related to plurality of predefined parameters corresponding to each product category stored in each of plurality of outlets, from sensor cluster. Further, the assessment system determines an ambience score of each product category in each of plurality of outlets based on corresponding monitored data and compliance conditions pre-set for each of plurality of predefined parameters of corresponding product category. Each of the product is associated with one of each of the product category. Thereafter, the assessment system determines compliance assessment score for each of plurality of outlets based on ambience score of each product category of each of plurality of outlets. Furthermore, the assessment system assess performance of each of plurality of outlets based on compliance assessment score.

### CROSS-REFERENCE TO RELATED APPLICATIONS

This application claims priority to Indian Patent Application No. 202341060565, filed on Aug. 9, 2023, which is hereby incorporated by reference in its entirety.

### FIELD

The present disclosure relates to field of automated assessment of a plurality of outlets using Internet of Things (IoT). Particularly, the present disclosure relates to a method and an assessment system for assessing performance of the plurality of outlets.

### BACKGROUND

Many perishable products including but not limited to soft drinks, milk, chocolates, beer, medicines, and vaccines need to be refrigerated at specific temperature and stored in specific conditions in retail outlets for them to be maintained fresh and sold. Consumer Packaged Goods (CPG)/Fast Moving Consumer Goods (FMCG) and pharmaceutical companies in such markets provide refrigerators or coolers to such retail outlets for storing their products in the required specific conditions. Typically, the refrigerators or coolers are assets of the brand since they are owned by the manufacturer. However, retailers may not always comply with ambience or conditions of the storage area that are required for a particular product to be maintained and sold. The ambience of the storage area relates to specific storage conditions in which the products must be stored. The storage area may relate to an asset such as a refrigerator, a cooler, a shelf in the retail store, and the like. Improper ambience of the storage area may affect quality of the products stored in the storage area. For instance, certain products such as food, beverages, medicines, and vaccines require specific storage conditions in terms of temperature, humidity, and other environmental factors. Also, many retail outlets do not adhere to the guidelines, e.g., either the assets (coolers/fridges) are not turned on, the products are not kept in the assets at all, or storing products of a competitor brand in the assets provided by a particular brand which leads to brand contamination. Further, the assets provided by the brands to the retail outlets are sometimes taken by the store owners to their residence for personal use, leading to change in ambience and products stored in the asset. Also, this may lead to an issue where customers may not be willing to buy products that are not refrigerated properly.

Traditional merchandising, sales force automation and distributor management systems used by manufacturers and their distributors lack the capability to perform in-store audits effectively to determine state of the products in the retail outlets and occurrence of brand contamination. One of the traditional techniques used is to hire third party auditors or empower the distributor sales representative to conduct in-store audits. However, such a technique is time consuming as the audit is done manually. Further, manual audits may not be as effective as technology-automated audits. The representatives may not be skilled at performing in-store audits effectively, hence the recording of ambience data and shelf-display status may be prone to human errors. This process of performing audits manually may be an expensive task. Further, due to the manual task, it may be difficult to cover a large sample space of the retail outlets. Also, it may be difficult to collect and aggregate data for an entire region, geography, or a large network of outlets, or to drill down at any outlet due to low sample space. Extrapolation of results needs to be done and the results are not accurate.

Some of the existing techniques disclose systems and methods for determining compliance with ambient conditions mentioned by an entity. The existing techniques teach about assessing the products expiry using micro-climatic sensors. If the products are not kept in ambient temperature, this may affect the product and affect the manufacturer of the product as the product is not in the condition to be sold. Such conditions may exist due to environmental conditions, negligence at the outlets, misuse of the storage areas provided for storing the products and various other factors. However, the existing techniques only teach methods that can monitor ambience conditions such as temperature, humidity etc., of products and identify usability of the products. However, the existing techniques do not teach any method by which a manufacturer can track how products of different product categories are stored at outlet level, or assess compliance levels of each product category at various outlets from a remote location and without manual interference.

The information disclosed in this background of the disclosure section is only for enhancement of understanding of the general background of the invention and should not be taken as an acknowledgement or any form of suggestion that this information forms the prior art already known to a person skilled in the art.

### SUMMARY

Disclosed herein is a method of assessing performance of a plurality of outlets. The method comprises receiving, by an assessment system, monitored data related to a plurality of predefined parameters corresponding to each product stored in each of a plurality of outlets, from one or more sensor cluster deployed in each of the plurality of outlets. Further, the method comprises determining an ambience score of each product category in each of the plurality of outlets based on the corresponding monitored data and one or more compliance conditions pre-set for each of the plurality of predefined parameters of the corresponding product category. Each of the product is associated with one of each of the product category. Thereafter, the method comprises determining a compliance assessment score for each of the plurality of outlets based on the ambience score of each product category of each of the plurality of outlets. The method further comprises assessing performance of each of the plurality of outlets based on the compliance assessment score.

Further, disclosed herein is an assessment system for assessing performance of a plurality of outlets. The assessment system comprises a processor and a memory. The memory is communicatively coupled to the processor and stores processor-executable instructions, which on execution, cause the processor to receive monitored data related to a plurality of predefined parameters corresponding to each product stored in each of a plurality of outlets, from one or more sensor cluster deployed in each of the plurality of outlets. Further, the processor determines an ambience score of each product category in each of the plurality of outlets based on the corresponding monitored data and one or more compliance conditions pre-set for each of the plurality of predefined parameters of the corresponding product category. Each of the product is associated with one of each of the product category. Thereafter, the processor determines a compliance assessment score for each of the plurality of outlets based on the ambience score of each product category of each of the plurality of outlets. The processor further assess performance of each of the plurality of outlets based on the compliance assessment score.

Furthermore, disclosed herein is a non-transitory computer readable medium including instruction stored thereon that when processed by at least one processor cause an object determination system to perform operations. The operations comprise receiving, by an assessment system, monitored data related to a plurality of predefined parameters corresponding to each product stored in each of a plurality of outlets, from one or more sensor cluster deployed in each of the plurality of outlets. Further, the operations comprise determining an ambience score of each product category in each of the plurality of outlets based on the corresponding monitored data and one or more compliance conditions pre-set for each of the plurality of predefined parameters of the corresponding product category. Each of the product is associated with one of each of the product category. Thereafter, the operations comprise determining a compliance assessment score for each of the plurality of outlets based on the ambience score of each product category of each of the plurality of outlets. The operations further comprise assessing performance of each of the plurality of outlets based on the compliance assessment score.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING FIGURES

The accompanying drawings, which are incorporated in and constitute a part of this disclosure, illustrate exemplary embodiments and, together with the description, explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and regarding the accompanying figures, in which:

FIG. 1A shows an exemplary architecture for assessing performance of a plurality of outlets in accordance with some embodiments of the present disclosure;

FIG. 1B shows an exemplary arrangement of a sensor cluster in accordance with some embodiments of the present disclosure;

FIG. 2 shows a detailed block diagram of an assessment system, in accordance with some embodiments of the present disclosure;

FIG. 3 shows a flowchart illustrating a method of assessing performance of a plurality of outlets, in accordance with some embodiments of the present disclosure; and

FIG. 4 illustrates a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the specific forms disclosed, but on the contrary, the disclosure is to cover all modifications, equivalents, and alternative falling within the scope of the disclosure.

The terms “comprises”, “comprising”, “includes”, or any other variations thereof, are intended to cover a non-exclusive inclusion, such that a setup, device, or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

### Exemplary Definitions of Terms Used in the Description

Outlet: Outlet may be a retail sales establishment which stores and sells products. As an example, the outlet may be, without limitation, a departmental store, a supermarket, a grocery store, a hypermarket, pharmacy, a general store, a cafeteria, and a confectionary store.

Storage area: Storage area may be used to store products related to one or more product categories. As an example, the storage area (also called product storage area) may be a warehouse, a refrigerated food storage such as a refrigerator, frozen food storage such as a freezer and a dry food storage area. As an example, the product category may include, without limitation, dairy products, personal care products, drinks, confectionary, fresh foods, home care products, tobacco products, bakery products, medical products, and cosmetic products.

Ambience of the storage area: Ambience of the storage area relates to specific storage conditions in which the products must be stored. As an example, the specific storage conditions may be predefined temperature range and predefined humidity range. For example, in case the storage area is the refrigerator and stores ice creams, the predefined temperature range may be between, e.g., −28° Celsius (C) and −10° C.

Ambience score: Ambience score may be a score calculated for a product category in an outlet. The ambience score may be determined based on one or more compliance conditions pre-set for each of plurality of predefined parameters of the corresponding product category. The plurality of predefined parameters may include, at least one of a threshold temperature range, a threshold humidity range, predefined location coordinate ranges such as X, Y and Z coordinates, a predefined planogram, predefined brand visibility conditions and brand contamination conditions.

Brand visibility: Brand visibility is a quantifier of how much the products of a particular brand are visible in the outlet relative to the preset brand visibility requirements. For instance, each outlet may provide a designated product storage area to a particular brand. The brand may pay for a designated place in the product storage area of the outlet. To comply with the brand visibility requirements, the outlet should place the products of the same brand in the designated place in the storage area provided by the brand. In case the outlet does not comply with the brand visibility requirements, the brand visibility may be considered to be low. Similarly, if the outlet complies with the brand visibility requirements, the brand visibility may be considered to be high. In some embodiments, the brand visibility may be quantified in a range of 0 to 1. In such a case, higher a value in the range 0 to 1, higher may be the brand visibility. Similarly, lower the value in the range 0 to 1, lower may be the brand visibility.

Brand contamination: Each brand may provide a product storage area such as a refrigerator for the outlet. In such a scenario, the outlet may have to store the products of that specific brand in the refrigerator to ensure that the ambience conditions or environment required for the products as specified by the manufacturer is complied with. As an example, consider a brand ‘Y’ provides a refrigerator to store soft drinks. The outlet must store the soft drinks of the brand ‘Y’ only in the refrigerator provided by the brand ‘Y’. However, in case the outlet stores soft drinks of another brand such as a competitor brand in the refrigerator provided by the brand ‘Y’, it may result in brand contamination.

Compliance assessment score: Compliance assessment score may be a total score determined for an outlet based on the ambience score computed for each product category of the outlet. The compliance assessment score may be used to assess performance of each of the plurality of outlets based on compliance of the products in the outlet with various requirements indicated by manufacturer of the product. Also, the compliance assessment score may be compared with predefined acceptable threshold level associated with the compliance assessment score for generating a rating for each outlet in the plurality of outlets.

Examples of the present disclosure relate to a method and an assessment system for assessing performance of a plurality of outlets. The plurality of outlets such as retail outlets may store products of multiple product categories and the products may belong to different brands/providers. The products must be stored as per the conditions agreed between the merchants of the plurality of the outlets and the brands/providers. The merchant may or may not store the products as per the conditions. In case the products are not stored as per the required and agreed upon conditions, a quality and salability of the products may be affected, which in turn may affect the merchants, consumers and in turn the manufacturers. Therefore, in one of the embodiments, the present disclosure assesses the performance of the outlets that may be based on the assessing storage conditions of the products in the outlets. The present disclosure, in one of the embodiments, generates real-time alerts and transmits the real-time alerts to users, such as a manufacturer and a distributor of the products. In some other embodiments, the real-time alerts may be generated and transmitted to a merchant of the outlet. Such alerts may help the merchant to comply with the conditions and improve the outlet's performance. In an embodiment, to access the storage conditions of the products, a plurality of predefined parameters corresponding to the products may be monitored. Further, to monitor the plurality of predefined parameters corresponding to each product stored in each of the plurality of outlets, one or more sensor cluster may be deployed in each of the plurality of outlets. In an embodiment, the one or more sensor cluster may be deployed in or in vicinity of the assets such as the refrigerator, the shelves and so forth. The one or more sensor cluster may be used to transmit monitored data (such as data monitored by the one or more sensor cluster of the products) to the proposed assessment system. The one or more sensor cluster may include multiple sensors for example, a temperature sensor, a humidity sensor, an image capturing unit, a location sensor, a cellular module, and a motion sensor to monitor the products. Also, the number of sensors may vary from outlet to outlet. As an example, the outlet such as a supermarket may have more than one sensor cluster based on a size of the supermarket. The monitored data from the one or more sensor cluster may be transmitted to the assessment system. Upon receiving the monitored data, the assessment system may determine an ambience score of each product category. The ambience score may be determined based on the monitored data and one or more compliance conditions. The one or more compliance conditions may be pre-set for each of the plurality of predefined parameters of the corresponding product category. As an example, a compliance condition of the one or more compliance conditions may be a temperature compliance. The temperature compliance for the product category “dairy products” may be pre-set and the dairy products stored in the outlet should be as per the temperature compliance. The merchant of the outlet must comply with the one or more compliance conditions to maintain a shelf life and properties of products in the product category as desired by the manufacturer. Upon determining the ambience score for each product category, the assessment system may further determine compliance assessment score for each of the plurality of outlets based on the ambience score. Thereafter, the assessment system may compare the compliance assessment score of each outlet with predefined acceptable threshold level associated with the plurality of predefined parameters. Based on the comparison, in an embodiment, a rating may be generated for each of outlet of the plurality of outlets. Moreover, the assessment system may perform one or more actions based on the compliance assessment score of each of the plurality of outlets.

In an embodiment, the proposed method may include automated assessment of the performance of the outlet using the received monitored data. This helps to eliminate manual work and manual errors associated with manual assessment of the outlets. In an embodiment, the one or more sensor cluster may be used to automatically monitor the ambience conditions of the products and the proposed method may include receiving the monitored data from the one or more sensor cluster. Such monitoring may help in identifying the products that may have been kept in undesired environment and may have expired without requirement of any manual intervention. In an embodiment, the proposed method determines brand visibility and brand contamination using trained Artificial Intelligence (AI) model. The outlet may provide a designated product storage area to a particular brand. The brand may pay for a designated place in the product storage area of the outlet. To comply with the brand visibility requirements, the outlet should place the products of the same brand in the designated area. This helps the brands to determine if the outlet is complying with the one or more compliance conditions, such as a compliance condition associated with the brand visibility. The one or more compliance conditions may be pre-set for each of the plurality of predefined parameters of the corresponding product category. In an embodiment, the proposed method determines the compliance assessment score for each of the plurality of outlets based on the ambience score and the one or more compliance conditions. The compliance assessment score may be compared with the predefined threshold to generate the rating for each of the plurality of outlets. The rating may be used by the brands to perform one or more actions on the outlet such as upgrading or downgrading a class of the outlet, increasing or decreasing supply of the products to the outlet, and adding outlet to a list of ineligible outlets and so forth. In an embodiment, the proposed method generates a real-time alert to the manufacturer of the products and the distributor of the products when the brand contamination occurs and/or the brand visibility is impacted which may reduce the compliance assessment score of the outlet. In some other embodiments, the real-time alerts may be generated to alert the merchant of the outlet when the brand contamination occurs and/or the brand visibility is impacted which may reduce the compliance assessment score of the outlet. This helps the merchant to take corrective actions which may help improve or maintain the compliance assessment score of the outlet. The real-time alerts may also be generated when the products are not stored as per the pre-set conditions which may spoil the products. In an embodiment, the proposed method also provides feedback to the outlet. This helps the merchants to improve the rating and the compliance assessment score may be utilized to upgrade the rating of the outlet and increase the supply of products to the outlet by the brands/suppliers. The method of the present disclosure may also enable aggregation of the compliance assessment scores across a network of outlets. This provides the brand or the supplier an overview of the performance of the plurality of outlets in a geographic location. This also helps the brand or the supplier to take upcoming decisions based on the existing performance.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

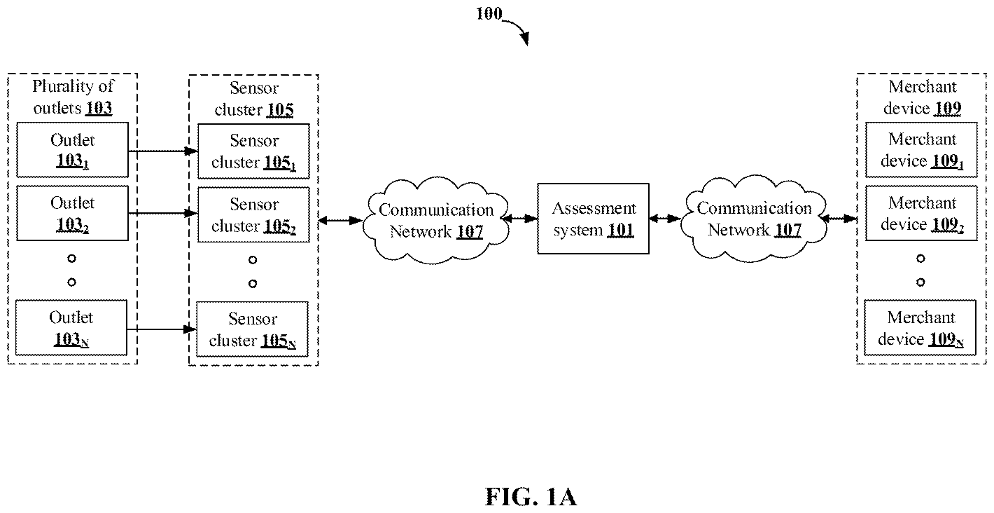

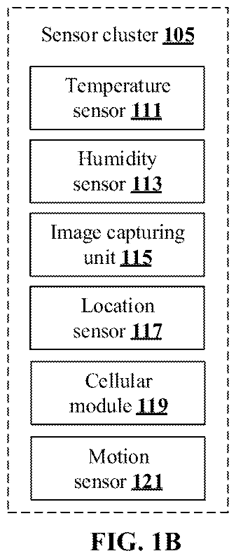

FIG. 1A shows an exemplary architecture for assessing performance of a plurality of outlets in accordance with some embodiments of the present disclosure.

Exemplary architecture may include a proposed assessment system, a plurality of outlets (also referred as plurality of outlets), one or more sensor cluster (also collectively referred as one or more sensor cluster or sensor cluster) and merchant devices (also referred merchant devices). As an example, the outlet may deploy a sensor cluster whereas the merchant of the outlet may have a device. The assessment system and the merchant devices may be connected using the communication network. As an example, the communication network may be a wired communication network, a wireless communication network or a combination of both, which enable internet connectivity. In an embodiment, the one or more sensor cluster may be deployed in the plurality of outlets, for e.g., a sensor cluster may be employed in an outlet, the sensor cluster may be employed in the outlet and the like. In an embodiment, an assessment system may be configured to assess performance of the plurality of outlets. The assessment system may be a computing device. As an example, the computing device may include, without limitation, a desktop computer, a laptop, a smartphone, a tablet phone, processing devices and the like. The assessment system may be associated with the plurality of outlets through the communication network. In an embodiment, the assessment system may receive monitored data from the one or more sensor cluster present at each of the plurality of outlets. In some embodiments, at each geographic location of the plurality of outlets, the assessment system may be present that may be local to the geographic location. The assessment system from the multiple geographic locations may be connected to a centralized system using the communication network. As an example, the communication network may be a wired communication network, a wireless communication network or a combination of both, which enable internet connectivity. As an example, each of the plurality of outlets may be, without limitation, a departmental store, a supermarket, a grocery store, a hypermarket, pharmacy, a general store, a cafeteria, or a confectionary store. In an embodiment, the plurality of outlets may store products related to one or more product categories. As an example, the product category may include, without limitation, dairy products, personal care products, drinks, confectionary, fresh foods, home care products, tobacco products, bakery products, medical products, and cosmetic products. In an embodiment, the one or more sensor cluster are deployed in each of the plurality of outlets.

FIG. 1B shows an exemplary arrangement of the sensor cluster in accordance with some embodiments of the present disclosure. The sensor cluster may include, without limitation, at least one of a temperature sensor, a humidity sensor, an image capturing unit, a location sensor, a cellular module, and a motion sensor.

The sensor cluster may be configured to monitor data associated with the various product categories. In an embodiment, the sensor cluster deployed in each of the plurality of outlets may vary in terms of type of sensors, number of sensors, position of sensors, and manner of deployment of sensors based on one or more outlet characteristics. In some embodiments, the sensor cluster may be deployed in a product storage area which is storing the products. As an example, the product storage area may be a warehouse, a refrigerated food storage such as a refrigerator, frozen food storage such as a freezer and a dry food storage area. In some embodiments, the sensor cluster may be deployed outside the product storage area. In one or more embodiments, one or more sensors of the sensor cluster may be deployed inside the product storage area, whereas remaining sensors of the sensor cluster may be deployed outside the product storage area. For example, the temperature sensor may be deployed inside the refrigerator, whereas the location sensor may be deployed outside the refrigerator. In another example, the image capturing unit may be placed outside the refrigerator to capture an image of the products stored inside the refrigerator.

Referring again to FIG. 1A, the assessment system may receive the monitored data from the sensor cluster and may utilize the pre-set one or more compliance conditions to determine the ambience score of each of the product category. The assessment system may further determine the compliance assessment score for each of the plurality of outlets based on the determined ambience score.

In some embodiments, the assessment system may generate a rating for each of the plurality of outlets. The rating may be based on the compliance assessment score and one or more outlet characteristics of the plurality of outlets. The one or more outlet characteristics may include, without limitation, at least one of: location of the plurality of outlets, class of the plurality of outlets, a scale of the plurality of outlets and a retail channel of the plurality of outlets. As an example, the retail store may deploy only one of the sensor cluster depending on the scale of the retail store, whereas a supermarket may deploy more than one of the sensor cluster as the scale of the supermarket may be comparatively bigger than the retail store.

In an embodiment, the merchant device may be a computing device available with merchant of each of the plurality of outlets. As an example, the computing device may include, without limitation, a desktop computer, a laptop, a smartphone, a tablet phone, processing devices and the like. In accordance with some embodiments, the assessment system 101 may be integrated with the merchant device.

In an embodiment, the assessment system may be configured to receive the monitored data related to a plurality of predefined parameters corresponding to each product stored in each of a plurality of outlets. In an embodiment, the monitored data may be received from the sensor cluster deployed in each of the plurality of outlets. The monitored data may be related to the plurality of predefined parameters corresponding to the products stored in the plurality of outlets. The plurality of predefined parameters corresponding to the products stored in each of the plurality of outlets may include, without limitation, temperature and humidity of the product storage area, a layout and location of the products in the product storage area, and images of the products stored in the product storage area. In some embodiments, the monitored data may also include the images of the products of each product category indicative of brand name of the product and a layout or a placement of the products within the storage area, that may help in determining type of the products and brand names of the products stored in the product storage area. The temperature sensor and the humidity sensor in the sensor cluster may be used to determine the temperature and humidity in the product storage area. Further, the image capturing unit may be used to capture images/videos, which may then be analyzed to determine the type of products stored in the product storage area and to determine the layout and location of the products in the product storage area. As an example, the type of products may include, at least one of the product category and the brand of the product. Moreover, the location sensor and the motion sensor may be configured to determine the location and layout of the products in the product storage area. Furthermore, the image capturing unit such as a camera may be used to capture images of the products in the product storage area to determine the brand names, the layout and the location of the products that may be utilized to determine the type of the products stored in the product storage area. In some embodiments, the location sensor and the motion sensor may be used to determine location of an asset such as the refrigerator or the cooler provided by the manufacturer of a certain brand of products. In a scenario where the location of the asset provided by the manufacturer of a certain brand of products is identified to be away from the location of the outlet, it may be indicated that the asset has been stolen or that the merchant has failed to comply with the requirements of the manufacturer, by using the asset for personal use rather than the usage as required by the manufacturer. In an embodiment, the cellular module in the sensor cluster may be used to transmit the monitored data to the assessment system using the communication network.

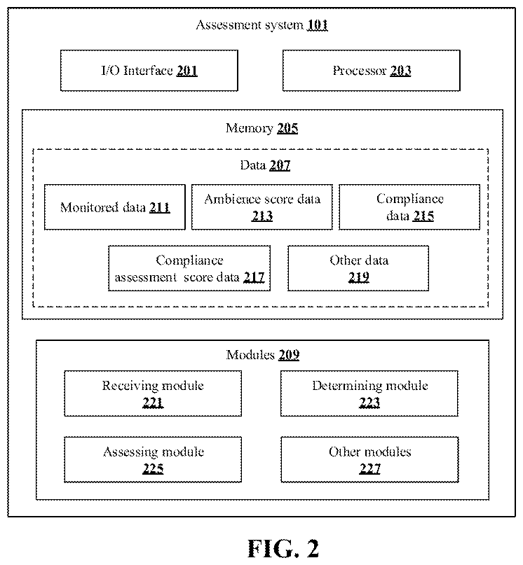

In an embodiment, upon receiving the monitored data, the assessment system may be configured to determine the ambience score of each product category in each of the plurality of outlets based on the corresponding monitored data and the one or more compliance conditions pre-set for each of the plurality of predefined parameters of the corresponding product category. In an embodiment, the ambience score may be calculated for each product category in each of the plurality of outlets. The plurality of outlets may store the products related to more than one category. In an embodiment, the one or more compliance conditions pre-set for each of the plurality of predefined parameters of the corresponding product category may include, at least one of a threshold temperature range, a threshold humidity range, predefined location ranges for X, Y and Z coordinate of a product stored in the product storage area, a predefined planogram (or a layout), and predefined brand visibility conditions and brand contamination conditions. The assessment system may use predefined equations to determine temperature compliance and humidity compliance of the product storage area. An exemplary equation is given in the description of FIG. 2.

In an embodiment, the assessment system may determine planogram compliance to determine the ambience score. The planogram is a diagram that depicts where specific products should be placed in the product storage area. The plurality of outlets may have the predefined planogram which may have to be complied by each of the plurality of outlets. The assessment system may use images captured using the image capturing unit in the sensor cluster to determine the planogram compliance. In an embodiment, the assessment system may use trained Artificial Intelligence (AI) model to perform image processing and compare the captured images and the predefined planogram given to each of the plurality of outlets. As an example, consider a brand ‘X’ has three different products namely, fruit juices, chocolates, and milk. The brand may provide a planogram for an outlet of the plurality of outlets that may depict that the fruit juices should be placed in row 1, the chocolates should be placed in row 2 and milk should be placed in row 3. The trained AI model may perform image processing techniques to determine if the outlet complies with the planogram given to the outlet. If the products placed in the product storage area of the outlet are as per the planogram, the planogram compliance may be considered to be high. If the products placed in the product storage area of the outlet may not be as per the planogram, the planogram compliance may be considered to be low. The planogram compliance may be related to layout and location of the products in the product storage area and may affect the ambience score. In some embodiments, the assessment system may predefine values associated with low, high and medium compliance categories that may help in determining the ambience score.

In some embodiments, the assessment system may use the trained AI model to perform image processing and detect brand visibility and brand contamination. In an embodiment, the assessment system may determine the brand visibility and brand contamination to determine the ambience score. In an embodiment, the outlet may provide a designated product storage area to the products of a particular brand manufacturer. In some embodiments, the brand manufacturer may pay for a designated place in the product storage area of the outlet. To comply with the brand visibility requirements, the outlet should place the products of the same brand in the designated area. In case the outlet does not comply with such a requirement, the brand visibility may be lower. This may also affect the ambience score. In some embodiments, the brand may provide a product storage area such as a refrigerator to the outlet. In such a scenario, the outlet may have to store the products of that specific brand in the refrigerator to ensure that the environment required for the products as specified by the manufacturer is complied with. As an example, consider the brand ‘Y’ provides a refrigerator to store soft drinks. The outlet must store the soft drinks of the brand ‘Y’ in the refrigerator provided by the brand ‘Y’. In case the outlet stores soft drinks of another brand, this may result in brand contamination. Brand contamination may result in, without limitation, a poor environment for the products, incorrect usage of the resources and product spoilage. This may also affect the ambience score.

In an embodiment, the assessment system may be configured to determine the compliance assessment score for each of the plurality of outlets based on the ambience score of each product category of each of the plurality of outlets. The compliance assessment score may be calculated using a predefined equation. The ambience score of each product category of similar brand may be used to determine the compliance assessment score.

In an embodiment, upon determining the compliance assessment score, the assessment system may be configured to assess performance of each of the plurality of outlets based on the compliance assessment score. In an embodiment, the assessment system may compare the compliance assessment score of each outlet with predefined acceptable threshold level associated with the compliance assessment score. Further, the assessment system may generate a rating for each outlet in the plurality of outlets based on the comparison and one or more outlet characteristics. The one or more outlet characteristics may include, without limitation, at least one of location of the plurality of outlets, class of the plurality of outlets and retail channel of the plurality of outlets. The location may include geographical location of each of the plurality of outlets. The plurality of outlets may be grouped under zone, city, state, and country. Moreover, the location of the plurality of outlets may be indicative of a type of locality of the plurality of outlets, and a population in and around the plurality of outlets. Furthermore, the class of each outlet may be a classification of the outlet performed based on the agreed terms of the manufacturer or a distributor with the outlet. The class of the outlet may also be determined based on the number of products sold by the outlet. As an example, the class may be platinum, gold, silver, and bronze. The retail channel of the outlet may be a classification done based on the retail channel used for sales with the outlet. As an example, the retail channel, may be traditional trade (distributed) or modem trade (direct). In an embodiment, the ratings may be generated each month and the ratings may be communicated to each of the plurality of outlets. In some embodiments, the ratings may be generated at a configurable duration such as daily, weekly, monthly, quarterly and yearly. In an embodiment, the ratings may be updated dynamically based on the compliance assessment score.

Furthermore, the assessment system may perform one or more actions based on the compliance assessment score of each of the plurality of outlets. The one or more actions may include, without limitation, sending real-time alerts to the manufacturer of the products, the distributor of the products and merchants of the plurality of outlets, providing feedback via the merchant device to merchants of the plurality of outlets, upgrading or downgrading the class of the plurality of outlets, increasing or decreasing supply of the products to the plurality of outlets, and adding one or more of the plurality of outlets to a list of ineligible outlets.

In an embodiment, the assessment system may be configured to generate and transmit the real-time or near real-time alerts to the manufacturer of the products and the distributor of the products, and the merchant of the outlet indicating occurrence of brand contamination and/or impact on brand visibility which may reduce the compliance assessment score of the outlet. The real-time or near real-time alerts may be transmitted to the merchant device associated with the merchants. Upon receiving such alerts, the merchant may perform an immediate action to overcome brand contamination and comply with the brand visibility conditions. As an example, when a product of brand ‘X’ is stored in a place designated for brand ‘Y’, the assessment system may transmit the alert to the merchant indicating brand contamination. Upon receiving the alert, the merchant may remove the product of brand ‘X’ from the place designated for brand ‘Y’. In some embodiments, the real-time alerts may be generated and transmitted to alert the merchant of the outlet indicating spoilage of the product. As an example, in case a product such as a medicine that must be refrigerated at a particular temperature may be kept at undesirable temperatures due to switching off of the refrigerator for a longer duration, the medicine may get spoiled due to reduced efficacy. Such expired medicine with the reduced efficacy may be dangerous for a consumer and selling of such medicine may be avoided. The assessment system may identify the expiry of the medicine may transmit the alert to the merchant indicating that the medicine may be unfit to sell.

In some embodiments, the assessment system may also provide feedback to the plurality of outlets. The feedback may be transmitted to the merchant device associated with the merchants of the plurality of outlets. The feedback may be sent, without limitation, at various durations, such as each month, each quarter and each year. This may provide an overview of the products stored in the plurality of outlets to the respective merchants. The feedback may include, without limitation, the compliance assessment score, the rating of the outlet, a list of expired products in the outlet, products placed at incorrect locations and list of parameters to be improved. Further, the assessment system may upgrade or downgrade rating of the outlet, increase or decrease supply of the products to the outlet, and add one or more outlets of the plurality of outlets to a list of ineligible outlets. This may be performed each month based on the compliance assessment score of the plurality of outlets. As an example, in case the compliance assessment score of the outlet is less than a predefined threshold, the assessment system may downgrade the rating of the outlet, decrease supply of the products to the outlet, and the outlet may be added to a list of ineligible outlets. In some embodiments, the list of the ineligible outlets may include the outlets to which the manufacturer/distributor may not provide promotions and offers on the products supplied by the manufacturer/distributor. In some other embodiments, the list of ineligible outlets may also include outlets to which the manufacturer/distributer may have stopped supplying products of certain product categories or all product categories due to compliance issues.

FIG. 2 shows a detailed block diagram of assessment system, in accordance with some embodiments of the present disclosure.

In some implementations, the assessment system may include an I/O interface, a processor and a memory. In an embodiment, the memory may be communicatively coupled to the processor. The processor may be configured to perform one or more functions of the assessment system for assessing performance of a plurality of outlets, using data and one or more modules of the assessment system. In an embodiment, the memory may store data.

In an embodiment, the data stored in the memory may include, without limitation, monitored data, ambience score data, compliance data, compliance assessment score data and other data. In some implementations, the data may be stored within the memory in the form of various data structures. Additionally, the data may be organized using data models, such as relational or hierarchical data models. The other data may include various temporary data and files generated by the one or more modules.

In an embodiment, the monitored data may include values related to a plurality of predefined parameters corresponding to each product stored in each of a plurality of outlets. The monitored data may be received from one or more sensor cluster deployed in each of the plurality of outlets. The plurality of predefined parameters corresponding to the products stored in each of the plurality of outlets may include, without limitation, temperature and humidity of a product storage area, layout and location of the products in the product storage area, and images of products stored in the product storage area. As an example, the type of products may include, at least one of the product category and the brand of the product. The monitored data may be used to determine the ambience score of each product category in each of the plurality of outlets.

In an embodiment, the ambience score data may include ambience score of each of the plurality of outlets. The ambience score may be a score calculated for a product category in an outlet based on the corresponding monitored data. Further, the ambience score data may be used to determine the compliance assessment score for each of the plurality of outlets. The ambience score may be determined using predefined equations.

In an embodiment, the compliance data may include one or more compliance conditions pre-set for each of the plurality of predefined parameters of the corresponding product category. The compliance data may be used along with the monitored data to determine the ambience score. In an embodiment, the one or more compliance conditions pre-set for each of the plurality of predefined parameters of the corresponding product category may include, at least one of, a threshold temperature range, a threshold humidity range, predefined location ranges for X, Y and Z coordinate of a product stored in the product storage area, a predefined planogram, and predefined brand visibility conditions and brand contamination conditions.

In an embodiment, the compliance assessment score data may include the compliance assessment score of each of the plurality of outlets. The compliance assessment score may be a total score determined for an outlet based on the ambience score computed for each product category of the outlet. The compliance assessment score may be used to assess performance of each of the plurality of outlets based on compliance of the products in the plurality of outlets with various requirements indicated by manufacturer of the product. Also, to generate the rating for each outlet in the plurality of outlets, the compliance assessment score may be compared with the predefined acceptable threshold level associated with the compliance assessment score. Further, based on the compliance assessment score of each of the plurality of outlets, one or more actions may be performed, which are explained in detail in further part of the description.

In an embodiment, the data may be processed by one or more modules of the assessment system. In some implementations, the one or more modules may be communicatively coupled to the processor for performing one or more functions of the assessment system. In an implementation, the one or more modules may include, without limiting to, a receiving module, a determining module, an assessing module and other modules.

As used herein, the term module may refer to an Application Specific Integrated Circuit (ASIC), an electronic circuit, a hardware processor (shared, dedicated, or group) and memory that execute one or more software or firmware programs, a combinational logic circuit, and/or other suitable components that provide the described functionality. In an implementation, each of the one or more modules may be configured as stand-alone hardware computing units. In an embodiment, the other modules may be used to perform various miscellaneous functionalities on the assessment system. It will be appreciated that such one or more modules may be represented as a single module or a combination of different modules.

In an embodiment, the receiving module may be configured to receive the monitored data related to the plurality of predefined parameters corresponding to each product stored in each of the plurality of outlets, from one or more sensor cluster deployed in each of the plurality of outlets. The sensor cluster deployed in each of the plurality of outlets may transmit the monitored data through the communication network. As an example, the communication network may be the wired communication network, a wireless communication network or a combination of both, which enable internet connectivity.

In an embodiment, the determining module may be configured to determine the ambience score for a product category in an outlet based on the corresponding monitored data and one or more compliance conditions pre-set for each of the plurality of predefined parameters of the corresponding product category. As an example, the temperature range of a refrigerator storing ice creams must be between −200 Celsius (C) and −10° C. In case the temperature is above the threshold temperature range, this may affect the ambience score as the one or more compliance conditions are not met. Further, the ice cream must be stored in the refrigerator provided by the brand of the ice cream to comply with conditions that monitor brand contamination. If the merchant has stored the ice creams in refrigerator of different brand, this may also affect the ambience score as the one or more compliance conditions may not be met. Consider exemplary values for one or more compliance conditions pre-set for dairy products category of a particular brand:
Threshold temperature range: −12° C. to −14° C.
Threshold humidity range: 30% and 50%
Predefined planogram: An image given to the merchant of the outlet.
Predefined brand visibility conditions: Milk in row 1, Curd in row 2 and butter in row 3.
Brand contamination conditions: No placing of products of other brands in the refrigerator.

In an embodiment, the determining module may further be configured to determine the compliance assessment score for an outlet based on the ambience score computed for each product category of the outlet. An exemplary equation to determine the ambience score and Compliance Assessment Score is shown below:

$$CAS = ( TC + ( LXC + LYC + LZC ) / 3 + HC + IC ) * 100 / 4 , unit \%$$

$$Where :$$

$$TC = 1 , if AT >= ET 1 and AT <= ET 2 , = \{ \vert ( ET 1 + ET 2 ) / 2 - AT ) \vert \} / max ( AT , ( ET 1 + ET 2 ) / 2 ) otherwise$$

$$LXC = 1 , if ALX >= ELX 1 and ALX <= ELX 2 , = \{ \vert ( ELX 1 + ELX 2 ) / 2 - ALX ) \vert \} / max ( ALX , ( ELX 1 + ELX 2 ) / 2 )$$

$$otherwise ,$$

$$LYC = 1 , if ALY >= ELY 1 and ALY <= ELY 2 , = \{ \vert ( ELY 1 + ELY 2 ) / 2 - ALY ) \vert \} / max ( ALY , ( ELY 1 + ELY 2 ) / 2 )$$

$$otherwise ,$$

$$LZC = 1 , if ALZ >= ELZ 1 and ALZ <= ELZ 2 , = \{ \vert ( ELZ 1 + ELZ 2 ) / 2 - ALZ ) \vert \} / max ( ALZ , ( ELZ 1 + ELZ 2 ) / 2 )$$

$$otherwise ,$$

$$HC = 1 , if AH >= EH 1 and AH <= EH 2 , = \{ \vert ( EH 1 + EH 2 ) / 2 - AH ) \vert \} / max ( AH , ( EH 1 + EH 2 ) / 2 )$$

$$otherwise$$

$$IC = Image Compliance score from Image Recognition Service$$

$$Where :$$

$$CAS : Compliance Assessment Score$$

$$TC : Temperature Compliance$$

$$LXC : Location Compliance in X axis$$

$$LYC : Location Compliance in Y axis$$

$$LZC : Location Compliance in Z axis$$

$$HC : Humidity Compliance$$

$$IC : Image Compliance score$$

$$max ( a , b ) : Maximum value between ‘ a ’ and ‘ b ’$$

$$AT : Actual Temperature reading from the sensor$$

$$ET 1 : Lower value of expected / compliant temperature range$$

$$ET 2 : Higher value of expected / compliant temperature range$$

$$ALX : Actual longitude reading from the GPS sensor$$

$$ELX 1 : Lower value of expected / compliant longitude range$$

$$ELX 2 : Higher value of expected / compliant longitude range$$

$$ALY : Actual latitude reading from the GPS sensor$$

$$ELY 1 : Lower value of expected / compliant latitude range$$

$$ELY 2 : Higher value of expected / compliant latitude range$$

$$ALZ : Actual altitude reading from the GPS sensor$$

$$ELZ 1 : Lower value of expected / compliant altitude range$$

$$ELZ 2 : Higher value of expected / compliant altitude range$$

$$AH : Actual Humidity reading from the sensor$$

$$EH 1 : Lower value of expected / compliant humidity range$$

$$EH 2 : Higher value of expected / compliant humidity range$$

In an embodiment, the determining module may determine network ambience score for a plurality of similar type of outlets, as an example, a chain of supermarkets. An exemplary equation to calculate the network ambience score is shown below:

$$NAS = ( \sum ( CASi ) / N ) ,$$

$$Where :$$

$$NCS is Network Ambience Score$$

$$CAS is Compliance Assessment Score$$

$$N is the number of outlets in the classification group ,$$

$$i = 1 to N ,$$

$$CASi = CAS : Compliance Assessment Score of the {i}^{′} th outlet in the classification group .$$

In an embodiment, the assessing module may be configured to assess performance of each of the plurality of outlets based on the compliance assessment score. The assessing module may compare the compliance assessment score of each outlet with the predefined acceptable threshold level associated with the compliance assessment score. As an example, the predefined acceptable threshold level may be 70%. Further, the assessing module may generate the rating for each outlet in the plurality of outlets based on the compliance assessment score and one or more outlet characteristics. The one or more outlet characteristics may include, without limitation, at least one of location of the outlet, class of the outlet and retail channel of the outlet. Each in the plurality of outlets is categorized based on the location of the outlet, class of the outlet and retail channel of the outlet. The assessing module generates the rating for each outlet based on the location of the outlet, the class of the outlet and the retail channel of the outlet. As an example, the rating for a supermarket may be generated based on the comparison with compliance scores of other supermarkets. In some embodiment, the assessing module may perform one or more actions based on the compliance assessment score of each of the plurality of outlets. The one or more actions may include, without limitation, providing real-time alerts to a manufacturer of the products, the distributor of the product and the merchant of the outlet, providing feedback via the merchant device to the outlet, upgrading or downgrading (or modifying) the class of the outlet, increasing or decreasing supply of the products to the outlet, and adding the outlet to a list of ineligible outlets (or determining one or more outlets of the plurality of outlets as the ineligible outlets). As an example, when a product of brand ‘X’ is stored in a place designated for brand ‘Y’, the assessing module may generate and transmit the alert to the merchant indicating brand contamination. Upon receiving the alert, the merchant may remove the product of brand ‘X’ from the storage area designated for brand ‘Y’. Also, a monthly report may be generated and the feedback may be provided to the outlet. As an example, the temperature of the refrigerator must be 0° C. to store certain products. However, the temperature of the refrigerator is set at 3° C. In the monthly summary report, the merchant may be notified the incorrect temperature value and the merchant may correct the temperature based on the feedback received.

Further, exemplary calculations to assess the performance of an outlet using exemplary monitored data is shown below:

$$Temperature Compliance ( TC ) :$$

$$Estimated temperature 1 ( lower limit ) , ET 1 = 5 degrees centigrade$$

$$Estimated temperature 2 ( upper limit ) , ET 2 = 15 degrees centigrade$$

$$Actual temperature , AT = 3 degrees$$

$$TC = \vert \{ ( 5 + 15 ) / 2 \} - 3 \vert / max \{ 3 , ( 5 + 15 ) / 2 \} , \\ where ‖ refers to modulus , = \vert ( 20 / 2 ) - 3 \vert / max \{ 3 , ( 20 / 2 ) \} = 7 / 10 = 0.7$$

$$Location Compliance X ( LCX ) :$$

$$Estimated location X 1 ( lower limit ) , \\ ELX 1 = 77.61 ( longitude E ; negative values specify west )$$

$$Estimated location X 2 ( lower limit ) , ELX 2 = 77.62$$

$$Actual location , ALX = 77.6101$$

$$LCX = 1$$

$$Location Compliance Y ( LCY ) :$$

$$Estimated location Y 1 ( lower limit ) , \\ ELY 1 = 12.91 ( latitude N ; negative values specify south )$$

$$Estimated location Y 2 ( upper limit ) , ELY 2 = 12.92$$

$$Actual location , ALY = 12.9166$$

$$LCY = 1$$

$$Location Compliance Z ( LCZ ) :$$

$$Estimated location Z 1 ( lower limit ) , \\ ELZ 1 = 200.5 ( ellipsoid height in metres )$$

$$Estimated location Z 2 ( upper limit ) , ELZ 2 = 250.5$$

$$Actual location , ALZ = 210$$

$$LCZ = 1$$

$$Humidity Compliance ( HC ) :$$

$$Estimated humidity 1 ( lower limit ) , EH 1 = 2.5$$

$$Estimated humidity 2 ( upper limit ) , EH 2 = 2.7$$

$$Actual humidity , AH = 2.1$$

$$HC = \vert \{ ( 2.5 + 2.7 ) / 2 \} - 2.1 \vert / max \{ 2.1 , ( 2.5 + 2.7 ) / 2 ) = \vert ( 5.2 / 2 ) - 2.1 \vert / max \{ 2.1 , ( 5.2 / 2 ) \} = 0.5 / 2.5 = 0.2$$

$$Image Compliance , IC = 0.6 ( 60 \% of recognized brands in the image belong to the brand owner of interest , 40 \% of the recognized brands refer to products of a different brand )$$

$$Compliance Assessment Score , CAS = [ TC + \{ ( LXC + LYC + LZC ) / 3 \} + HC + IC ] * 100 / 4 = [ 0.7 + \{ ( 1 + 1 + 1 ) / 3 \} + 0.2 + 0.6 ] * 100 / 4 = ( 2.5 * 100 ) / 4 = 62.5 \%$$

$$Predefined Acceptable Threshold level = 70 \%$$

$$Since CAS is lesser than threshold , \\ it may trigger the Compliance Action Workflow .$$

In an embodiment, the ambience score is a score calculated for a product category in an outlet. The ambience score may be determined based on one or more compliance conditions pre-set for each of the plurality of predefined parameters of the corresponding product category may include, at least one of, a threshold temperature range, a threshold humidity range, predefined location ranges for X, Y and Z coordinate, a predefined planogram, and predefined brand visibility conditions and brand contamination conditions. Based on the ambience score, the compliance assessment score may be determined. As shown in the above example, assessing module may first determine the ambience score i.e., temperature compliance, humidity compliance and location compliance. Upon determining the ambience score, assessing module may assess the compliance assessment score. If the compliance assessment score is less than the predefined acceptable threshold level, the assessing module may downgrade the rating of the outlet and decrease supply of the products to the outlet. Further, in case the merchant of the outlet does not take corrective actions even after receiving alerts from the assessing module, the assessing module may add the outlet to a list of ineligible outlets.

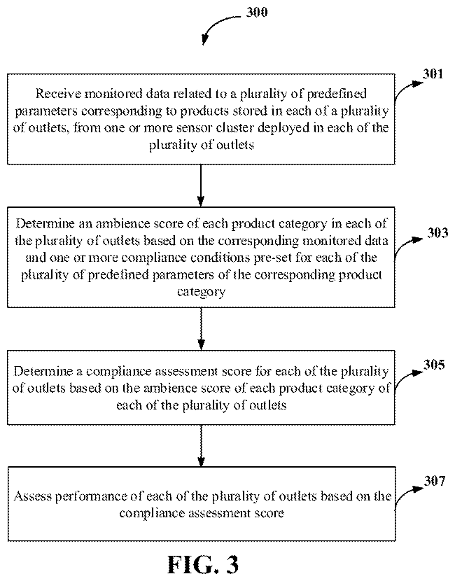

FIG. 3 shows a flowchart illustrating a method of assessing performance of a plurality of outlets, in accordance with some embodiments of the present disclosure.

As illustrated in FIG. 3, the method may include one or more blocks illustrating a method of assessing performance of the plurality of outlets using the assessment system illustrated in FIG. 2. The method may be described in the general context of computer executable instructions. Generally, computer executable instructions can include routines, programs, objects, components, data structures, procedures, modules, and functions, which perform specific functions or implement specific abstract data types.

The order in which the method is described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

At block 301, the method may include receiving, by the processor of the assessment system, the monitored data related to the plurality of predefined parameters corresponding to each product stored in each of a plurality of outlets, from at one or more sensor cluster deployed in each of the plurality of outlets. The plurality of predefined parameters corresponding to the products stored in each of the plurality of outlets may include, without limitation, temperature and humidity of a product storage area, layout and location of the products in the product storage area, and images of products stored in the product storage area. The sensor cluster may include, without limitation, at least one of temperature sensor, humidity sensor, an image capturing unit, a location sensor, a cellular module, and a motion sensor. In an embodiment, the sensor cluster deployed in each of the plurality of outlets may vary in terms of type of sensors, number of sensors, position of sensors, and manner of deployment of sensors based on one or more outlet characteristics.

At block 303, the method may include determining, by the processor, the ambience score of each product category in each of the plurality of outlets based on the corresponding monitored data and one or more compliance conditions pre-set for each of the plurality of predefined parameters of the corresponding product category.

At block 305, the method may include determining, by the processor, the compliance assessment score for each of the plurality of outlets based on the ambience score of each product category of each of the plurality of outlets.

At block 307, the method may include assessing, by the processor, performance of each of the plurality of outlets based on the compliance assessment score. In an embodiment, the processor compares the compliance assessment score of each outlet with predefined acceptable threshold level associated with the compliance assessment score. Further, the processor generates the rating for each of outlet in the plurality of outlets based on the compliance assessment score and one or more outlet characteristics. The one or more outlet characteristics may include, without limitation, at least one of location of the outlet, class of the outlet and retail channel of the outlet. In an embodiment, the processor performs one or more actions based on the compliance assessment score of each of the plurality of outlets. The one or more actions may include, without limitation, real-time alerts to a manufacturer of the products, a distributor of the product and a merchant of an outlet, providing feedback to the outlet, upgrading or downgrading rating of the outlet, increasing or decreasing supply of the products to the outlet, and adding outlet to a list of ineligible outlets.

### Computer System

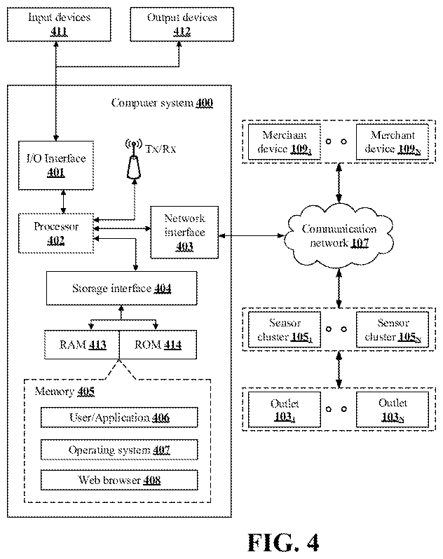

FIG. 4 illustrates a block diagram of an exemplary computer system for implementing embodiments consistent with the present disclosure. FIG. 4 may be construed in conjunction with elements of FIG. 1A, FIG. 1B and FIG. 2. In an embodiment, the computer system may be the assessment system illustrated in FIG. 1. The computer system may include a central processing unit (“CPU” or “processor” or “memory controller”). The processor may comprise at least one data processor for executing program components for executing user- or system-generated business processes. A user may include a network manager, an application developer, a programmer, an organization or any system/sub-system being operated parallelly to the computer system. The processor may include specialized processing units such as integrated system (bus) controllers, memory controllers/memory management control units, floating point units, graphics processing units, digital signal processing units, etc.

The processor may be disposed in communication with one or more Input/Output (I/O) devices via I/O interface. The I/O interface may employ communication protocols/methods such as, without limitation, audio, analog, digital, stereo, IEEE®-1394, serial bus, Universal Serial Bus (USB), infrared, PS/2, BNC, coaxial, component, composite, Digital Visual Interface (DVI), high-definition multimedia interface (HDMI), Radio Frequency (RF) antennas, S-Video, Video Graphics Array (VGA), IEEE® 802.n/b/g/n/x, Bluetooth, cellular (e.g., Code-Division Multiple Access (CDMA), High-Speed Packet Access (HSPA+), Global System For Mobile Communications (GSM), Long-Term Evolution (LTE) or the like), etc. Using the I/O interface, the computer system may communicate with one or more I/O devices.

In some embodiments, the processor may be disposed in communication with a network via a network interface. The network interface may communicate with the network. The network interface may employ connection protocols including, without limitation, direct connect, Ethernet (e.g., twisted pair 10/100/1000 Base T), Transmission Control Protocol/Internet Protocol (TCP/IP), token ring, IEEE® 802.11a/b/g/n/x, etc.

In an implementation, the preferred network may be implemented as one of the several types of networks, such as intranet or Local Area Network (LAN) and such within the organization. The preferred network may either be a dedicated network or a shared network, which represents an association of several types of networks that use a variety of protocols, for example, Hypertext Transfer Protocol (HTTP), Transmission Control Protocol/Internet Protocol (TCP/IP), Wireless Application Protocol (WAP) etc., to communicate with each other. Further, the network may include a variety of network devices, including routers, bridges, servers, computing devices, storage devices, etc. Using the network interface and the network, the computer system may communicate with a plurality of outlets and merchant devices.

In some embodiments, the processor may be disposed in communication with a memory (e.g., RAM, ROM, etc. as shown in FIG. 4) via a storage interface. The storage interface may connect to memory including, without limitation, memory drives, removable disc drives, etc., employing connection protocols such as Serial Advanced Technology Attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory may store a collection of program or database components, including, without limitation, user/application interface, an operating system, a web browser, and the like. In some embodiments, computer system may store user/application data, such as the data, variables, records, etc. as described in this disclosure. Such databases may be implemented as fault-tolerant, relational, scalable, secure databases such as Oracle® or Sybase® or PostgreSQL®.

The operating system may facilitate resource management and operation of the computer system. Examples of operating systems include, without limitation, APPLE® MACINTOSH®OS X®, UNIX®, UNIX-like system distributions (E.G., BERKELEY SOFTWARE DISTRIBUTION® (BSD), FREEBSD®, NETBSD®, OPENBSD, etc.), LINUX® DISTRIBUTIONS (E.G., RED HAT®, UBUNTU®, KUBUNTU®, etc.), IBM® OS/2®, MICROSOFT®WINDOWS®(XP®, VISTA®/7/8, 10 etc.), APPLE® IOS®, GOOGLE™ ANDROID™, BLACKBERRY®OS, or the like.

The user interface may facilitate display, execution, interaction, manipulation, or operation of program components through textual or graphical facilities. For example, the user interface may provide computer interaction interface elements on a display system operatively connected to the computer system, such as cursors, icons, check boxes, menus, scrollers, windows, widgets, and the like. Further, Graphical User Interfaces (GUIs) may be employed, including, without limitation, APPLE® MACINTOSH® operating systems' Aqua®, IBM® OS/2®, MICROSOFT®WINDOWS®(e.g., Aero, Metro, etc.), web interface libraries (e.g., ActiveX®, JAVA®, JAVASCRIPT®, AJAX, HTML, ADOBE® FLASH®, etc.), or the like.

The web browser may be a hypertext viewing application. Secure web browsing may be provided using Secure Hypertext Transport Protocol (HTTPS), Secure Sockets Layer (SSL), Transport Layer Security (TLS), and the like. The web browsers may utilize facilities such as AJAX, DHTML, ADOBE® FLASH®, JAVASCRIPT®, JAVA®, Application Programming Interfaces (APIs), and the like. Further, the computer system may implement a mail server stored program component. The mail server may utilize facilities such as ASP, ACTIVEX®, ANSI® C++/C#, MICROSOFT®, .NET, CGI SCRIPTS, JAVA®, JAVASCRIPT®, PERL®, PHP, PYTHON®, WEBOBJECTS®, etc. The mail server may utilize communication protocols such as Internet Message Access Protocol (IMAP), Messaging Application Programming Interface (MAPI), MICROSOFT® exchange, Post Office Protocol (POP), Simple Mail Transfer Protocol (SMTP), or the like. In some embodiments, the computer system may implement a mail client stored program component. The mail client may be a mail viewing application, such as APPLE®MAIL, MICROSOFT®ENTOURAGE®, MICROSOFT®OUTLOOK®, MOZILLA® THUNDERBIRD®, and the like.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., non-transitory. Examples include Random Access Memory (RAM), Read-Only Memory (ROM), volatile memory, nonvolatile memory, hard drives, Compact Disc (CD) ROMs, Digital Video Disc (DVDs), flash drives, disks, and any other known physical storage media.

### Advantages of the Embodiments of the Present Disclosure are Illustrated Herein:

In an embodiment, the proposed method may enable assessment of the performance of the outlet using the received monitored data. This helps to eliminate manual work and manual errors associated with manual assessment of the outlets.

In an embodiment, the one or more sensor cluster may be used to monitor the ambience conditions and the proposed method receives monitored data from at least one sensor cluster. This helps to automatically monitor product ambience and product expiration without manual intervention. In an embodiment, the proposed method may include determination of the brand visibility and brand contamination using trained Artificial Intelligence (AI) model. The outlet may provide a designated product storage area to a particular brand. The brand may pay for a designated place in the product storage area of the outlet. To comply with the brand visibility requirements, the outlet should place the products of the same brand in the designated area. This helps the brands to determine if the outlet is complying with one or more compliance conditions pre-set for each of the plurality of predefined parameters of the corresponding product category.

In an embodiment, the proposed method may include determination of the compliance assessment score for each of the plurality of outlets. The compliance assessment score is compared with predefined threshold and a rating for each of the plurality of outlets is generated. The rating is used by the brands to perform one or more actions on the outlet such as upgrading or downgrading the class of the outlet, increasing or decreasing supply of the products to the outlet, and adding outlet to a list of ineligible outlets.

In an embodiment, the proposed method may enable generation and transmission of a real-time alert to the outlet when brand contamination and/or brand visibility is impacted which may reduce the compliance assessment score of the outlet. This helps the merchant to take corrective actions which may improve the compliance assessment score of the outlet. The real-time alerts may also be generated when the products are not stored as per the pre-set conditions which may spoil the products. In an embodiment, the proposed method also provides feedback to the outlet. This helps the merchants to improve the rating and the compliance assessment score may upgrade the rating of the outlet and increase the supply of products to the outlet by the brands/suppliers.

In an embodiment, the present disclosure may also enable aggregation of the compliance assessment score across a network of outlets. This provides the brand or the supplier an overview of the performance of the plurality of outlets in a geographic location. This also helps the brand or the supplier to take upcoming decisions based on the existing performance.

As stated above, it shall be noted that the method of the present disclosure may be used to overcome various technical problems related to assessing performance of a plurality of outlets. In other words, the disclosed method has a practical application and provides a technically advanced solution to the technical problems associated with the existing approach into assessing performance of a plurality of outlets.

In light of the technical advancements provided by the disclosed method, the claimed steps, as discussed above, are not routine, conventional, or well-known aspects in the art, as the claimed steps provide the aforesaid solutions to the technical problems existing in the conventional technologies. Further, the claimed steps clearly bring an improvement in the functioning of the system itself, as the claimed steps provide a technical solution to a technical problem.

The terms “an embodiment”, “embodiment”, “embodiments”, “the embodiment”, “the embodiments”, “one or more embodiments”, “some embodiments”, and “one embodiment” mean “one or more (but not all) embodiments of the disclosure or invention(s)” unless expressly specified otherwise.

The terms “including”, “comprising”, “having” and variations thereof mean “including but not limited to”, unless expressly specified otherwise.

The enumerated listing of items does not imply that any or all the items are mutually exclusive, unless expressly specified otherwise. The terms “a”, “an” and “the” mean “one or more”, unless expressly specified otherwise.

A description of an embodiment with several components in communication with each other does not imply that all such components are required. On the contrary, a variety of optional components are described to illustrate the wide variety of possible embodiments of the present disclosure.

When a single device or article is described herein, it will be clear that more than one device/article (whether they cooperate) may be used in place of a single device/article. Similarly, where more than one device/article is described herein (whether they cooperate), it will be clear that a single device/article may be used in place of the more than one device/article or a different number of devices/articles may be used instead of the shown number of devices or programs. The functionality and/or features of a device may be alternatively embodied by one or more other devices which are not explicitly described as having such functionality/features. Thus, other embodiments of present disclosure need not include the device itself.

Finally, the language used in the specification has been principally selected for readability and instructional purposes, and it may not have been selected to delineate or circumscribe the inventive subject matter. It is therefore intended that the scope of the present disclosure be limited not by this detailed description, but rather by any claims that issue on an application based here on. Accordingly, the embodiments of the present disclosure are intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

Referral Numerals:

| Reference Number | Description |
|---|---|
| 101 | Assessment system |
| 1031-103N | Plurality of outlets |
| 1051-105N | Sensor cluster |
| 107 | Communication network |
| 1091-109N | Merchant device |
| 111 | Temperature sensor |
| 113 | Humidity sensor |
| 115 | Image capturing unit |
| 117 | Location sensor |
| 119 | Cellular module |
| 121 | Motion sensor |
| 201 | I/O Interface |
| 203 | Processor |
| 205 | Memory |
| 207 | Data |
| 209 | Modules |
| 211 | Monitored data |
| 213 | Ambience score data |
| 215 | Compliance data |
| 217 | Compliance assessment |
| | score data |
| 219 | Other data |
| 221 | Receiving module |
| 223 | Determining module |
| 225 | Assessing module |
| 227 | Other modules |
| 400 | Computer system |
| 401 | I/O Interface of the exemplary |
| | computer system |
| 402 | Processor of the exemplary |
| | computer system |
| 403 | Network interface |
| 404 | Storage interface |
| 405 | Memory of the exemplary |
| | computer system |
| 406 | User/Application |
| 407 | Operating system |
| 408 | Web browser |
| 411 | Input devices |
| 412 | Output devices |
| 413 | RAM |
| 414 | ROM |

What is claimed is:

1. A method of assessing performance of a plurality of outlets, the method comprising:
receiving monitored data related to a plurality of predefined parameters corresponding to each product stored in each of the plurality of outlets;
determining an ambience score of each product category in each of the plurality of outlets based on the corresponding monitored data and one or more compliance conditions pre-set for each of the plurality of predefined parameters of the corresponding product category, wherein each of the product is associated with one of each of the product category;
determining a compliance assessment score for each of the plurality of outlets based on the ambience score of each of the product category of each of the plurality of outlets; and
assessing performance of each of the plurality of outlets based on the compliance assessment score.

2. The method as claimed in claim 1, wherein the plurality of predefined parameters corresponding to each of the product stored in each of the plurality of outlets are associated with at least one of: temperature of a storage area of each of the product, humidity of the storage area of each of the product, location of each of the product in the storage area and images of each of the product stored in the storage area, and wherein the images are indicative of at least one of: a layout associated with each of the product in the storage area, and a brand name of each of the product in the storage area.

3. The method as claimed in claim 1, wherein the monitored data is received from one or more sensor cluster deployed in each of the plurality of outlets, and wherein the one or more sensor cluster comprises at least one of: temperature sensor, humidity sensor an image capturing unit, a location sensor, a cellular module, and a motion sensor.

4. The method as claimed in claim 3, wherein the one or more sensor cluster deployed in each of the plurality of outlets varies in terms of type of sensors, number of sensors, position of sensors, and manner of deployment of sensors based on one or more outlet characteristics.

5. The method as claimed in claim 1, wherein assessing the performance comprises:
comparing the compliance assessment score of each outlet with predefined acceptable threshold level associated with the compliance assessment score; and
generating a rating for each of outlet in the plurality of outlets based on the comparison and one or more outlet characteristics, wherein the one or more outlet characteristics comprises at least one of: a location of the outlet, or a class of the outlet and a retail channel of the outlet.

6. The method as claimed in claim 1, wherein assessing the performance further comprises:
performing one or more actions based on the compliance assessment score of each of the plurality of outlets, wherein the one or more actions comprises: providing real-time alerts to at least one of a manufacturer of each of the product, a distributor of each of the product and merchants of each of the plurality of outlets, providing feedback via a merchant device to the merchants of each of the plurality of outlets, upgrading or downgrading a class of one or more outlets of the plurality of outlets, modifying a supply of one or more of each of the product to one or more of each of the plurality of outlets, and determining one or more outlets of the plurality of outlets as ineligible outlets.

7. An assessment system for assessing performance of a plurality of outlets, the assessment system comprising:
a processor; and
a memory, communicatively coupled to the processor, wherein the memory stores processor-executable instructions, which, on execution, causes the processor to:
receive monitored data related to a plurality of predefined parameters corresponding to each product stored in each of a plurality of outlets, from one or more sensor cluster deployed in each of the plurality of outlets;
determine an ambience score of each product category in each of the plurality of outlets based on the corresponding monitored data and one or more compliance conditions pre-set for each of the plurality of predefined parameters of the corresponding product category, wherein each of the product is associated with one of each of the product category;
determine a compliance assessment score for each of the plurality of outlets based on the ambience score of each product category of each of the plurality of outlets; and
assess performance of each of the plurality of outlets based on the compliance assessment score.

8. The assessment system as claimed in claim 7, wherein the plurality of predefined parameters corresponding to each of the product stored in each of the plurality of outlets are associated with at least one of: temperature of a storage area of each of the product, humidity of the storage area of each of the product, location of each of the product in the storage area and images of products stored in the storage area,
wherein the images are indicative of at least one of: a layout associated with each of the product in the storage area, and a brand name of each of the product in the storage area.

9. The assessment system as claimed in claim 7, wherein the one or more sensor cluster comprises at least one of: temperature sensor, humidity sensor, an image capturing unit, a location sensor, a cellular module, and a motion sensor.

10. The assessment system as claimed in claim 7, wherein the one or more sensor cluster deployed in each of the plurality of outlets varies in terms of type of sensors, number of sensors, position of sensors, and manner of deployment of sensors based on one or more outlet characteristics.

11. The assessment system as claimed in claim 7, wherein to assess the performance, the processor is configured to:
compare the compliance assessment score of each outlet with predefined acceptable threshold level associated with the compliance assessment score; and
generate a rating for each of outlet in the plurality of outlets based on the comparison and one or more outlet characteristics, wherein the one or more outlet characteristics comprises at least one of: a location of the outlet, or a class of the outlet and a retail channel of the outlet.

12. The assessment system as claimed in claim 7, wherein to assess the performance, the processor is further configured to:
perform one or more actions based on the compliance assessment score of each of the plurality of outlets, wherein the one or more actions comprises: providing real-time alerts to at least one of a manufacturer of each of the product, a distributor of each of the product and a merchant of each of the plurality of outlets, providing feedback via a merchant device to the merchants of each of the plurality of outlets, upgrading or downgrading a class of one or more outlets of the plurality of outlets, modifying a supply of one or more of each of the product to one or more of each of the plurality of outlets, and determining one or more outlets of the plurality of outlets as ineligible outlets.

13. A non-transitory computer readable medium including instruction stored thereon that when processed by at least one processor cause an assessment system to perform operations comprising:
receiving monitored data related to a plurality of predefined parameters corresponding to each product stored in each of the plurality of outlets;
determining an ambience score of each product category in each of the plurality of outlets based on the corresponding monitored data and one or more compliance conditions pre-set for each of the plurality of predefined parameters of the corresponding product category, wherein each of the product is associated with one of each of the product category;
determining a compliance assessment score for each of the plurality of outlets based on the ambience score of each of the product category of each of the plurality of outlets; and
assessing performance of each of the plurality of outlets based on the compliance assessment score.

14. The non-transitory computer readable medium as claimed in claim 13, wherein the plurality of predefined parameters corresponding to each of the product stored in each of the plurality of outlets are associated with at least one of: temperature of a storage area of each of the product, humidity of the storage area of each of the product, location of each of the product in the storage area and images of products stored in the storage area,
and wherein the images are indicative of at least one of: a layout associated with each of the product in the storage area, and a brand name of each of the product in the storage area.

15. The non-transitory computer readable medium as claimed in claim 13, wherein the monitored data is received from one or more sensor cluster deployed in each of the plurality of outlets, and
wherein the one or more sensor cluster comprises at least one of: temperature sensor, humidity sensor, an image capturing unit, a location sensor, a cellular module, and a motion sensor.

16. The non-transitory computer readable medium as claimed in claim 15, wherein the one or more sensor cluster deployed in each of the plurality of outlets varies in terms of type of sensors, number of sensors, position of sensors, and manner of deployment of sensors based on one or more outlet characteristics.

17. The non-transitory computer readable medium as claimed in claim 13, wherein assessing the performance comprises:
comparing the compliance assessment score of each outlet with predefined acceptable threshold level associated with the compliance assessment score; and
generating a rating for each of outlet in the plurality of outlets based on the comparison and one or more outlet characteristics, wherein the one or more outlet characteristics comprises at least one of: a location of the outlet, or a class of the outlet and a retail channel of the outlet.

18. The non-transitory computer readable medium as claimed in claim 13, wherein assessing the performance further comprises:
performing one or more actions based on the compliance assessment score of each of the plurality of outlets, wherein the one or more actions comprises: providing real-time alerts to at least one of a manufacturer of each of the product, a distributor of each of the product and a merchant of each of the plurality of outlets, providing feedback via a merchant device to the merchants of each of the plurality of outlets, upgrading or downgrading a class of one or more outlets of the plurality of outlets, modifying a supply of one or more of each of the product to one or more of each of the plurality of outlets, and determining one or more outlets of the plurality of outlets as ineligible outlets.
